(19) United States
(12) Patent Application Publication
(10) Pub. No.: US 2024/0288685 A1
(43) Pub. Date: Aug. 29, 2024

(54) OPTICAL MODULE AND OPTICAL DEVICE

(71) Applicant: Murata Manufacturing Co., Ltd., Nagaokakyo-shi (JP)

(72) Inventors: Yuuki ISHII, Nagaokakyo-shi (JP); Yuka TANAKA, Nagaokakyo-shi (JP); Katsuhiro TABUCHI, Nagaokakyo-shi (JP); Takahide NAKADOI, Nagaokakyo-shi (JP); Noritaka KISHI, Nagaokakyo-shi (JP); Hitoshi SAKAGUCHI, Nagaokakyo-shi (JP)

(21) Appl. No.: 18/655,584

(22) Filed: May 6, 2024

Related U.S. Application Data
(63) Continuation of application No. PCT/JP2022/023915, filed on Jun. 15, 2022.

(30) Foreign Application Priority Data
Nov. 30, 2021 (JP) 2021-194451

(51) Int. Cl. G02B 27/00; B06B 1/06; G02B 7/02

(52) U.S. Cl. CPC G02B 27/0006; B06B 1/0651; G02B 7/02

(57) ABSTRACT

An optical module includes a translucent body, a vibrator that is tubular and supports the translucent body, a piezoelectric element located at the vibrator to vibrate the vibrator, and an inner-layer optical component at an inner side portion of the vibrator. The inner-layer optical component includes an inner-layer lens that faces the translucent body, a recess that is recessed in a thickness direction of the inner-layer lens and includes a curvature on a surface of the inner-layer lens facing the translucent body, and a gap is located between the translucent body and the recess of the inner-layer lens.

### CROSS REFERENCE TO RELATED APPLICATIONS

This application claims the benefit of priority to Japanese Patent Application No. 2021-194451 filed on Nov. 30, 2021 and is a Continuation Application of PCT Application No. PCT/JP2022/023915 filed on Jun. 15, 2022. The entire contents of each application are hereby incorporated herein by reference.

### BACKGROUND OF THE INVENTION

### 1. Field of the Invention

The present invention relates to optical modules and optical devices that each remove a liquid droplet or the like by vibration.

### 2. Description of the Related Art

Japanese Unexamined Patent Application Publication No. 2017-170303 discloses a liquid droplet exclusion device including a vibration generation member that is connected to an end portion of a curved surface that forms a dome portion of an optical element, the vibration generation member generating a bending vibration in the dome portion. In the liquid droplet exclusion device disclosed in Japanese Unexamined Patent Application Publication No. 2017-170303, a drip-resistant cover and a piezoelectric element are adhesively fixed to each other, and the drip-resistant cover is caused to bend and vibrate by the vibration of the piezoelectric element, thereby removing liquid droplets and the like adhering to the surface of the drip-resistant cover.

### SUMMARY OF THE INVENTION

In the device disclosed in Japanese Unexamined Patent Application Publication No. 2017-170303, there is still room for improvement in terms of reducing or preventing the vibration attenuation.

According to an example embodiment of the present invention, an optical module includes a translucent body, a vibrator that is tubular and supports the translucent body, a piezoelectric element located at the vibrator to vibrate the vibrator, and an inner-layer optical component located at an inner side portion of the vibrator, wherein the inner-layer optical component includes an inner-layer lens that faces the translucent body, a first recess that is recessed in a thickness direction of the inner-layer lens and includes a curvature on a surface of the inner-layer lens facing the translucent body, and a gap is located between the translucent body and the first recess of the inner-layer lens.

According to another example embodiment of the present invention, an optical device includes the optical module according to the above example embodiment, and an optical element at the optical module.

Example embodiments of the present invention provide optical modules and optical devices each capable of reducing or preventing vibration attenuation.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view showing an example of an optical device in Example Embodiment 1 according to the present invention.

FIG. 2 is a schematic cross-sectional view showing an example of a configuration of the optical device in Example Embodiment 1 according to the present invention.

FIG. 3 is a block diagram showing an example of a functional configuration of the optical device in Example Embodiment 1 according to the present invention.

FIGS. 4A and 4B are schematic views for describing a gap between a translucent body and an inner-layer lens.

FIG. 5 is a schematic view for describing Comparative Example 1 and Example 1.

FIG. 6 is a graph showing an example of a simulation result of a displacement amount of a translucent body and acoustic pressure in Comparative Example 1 and Example 1.

FIG. 7 is a view showing an example of a displacement distribution and an acoustic pressure distribution in Comparative Example 1 and Example 1.

FIG. 8 is a graph showing an example of a relationship between a dimension of a gap and the displacement amount.

FIG. 9 is a schematic view for describing a standing wave.

FIG. 10 is a graph showing an example of an analysis result of a relationship between displacement of the translucent body and the acoustic pressure.

FIG. 11 is an enlarged graph of the graph in FIG. 10.

FIG. 12 is a schematic cross-sectional view showing a main configuration of an optical module in Modification Example 1.

FIG. 13 is a schematic cross-sectional view showing a main configuration of an optical device in Modification Example 2.

### DETAILED DESCRIPTION OF THE EXAMPLE EMBODIMENTS

In a vehicle provided with an imaging unit including an imaging element or the like in a front portion or a rear portion of the vehicle, an image acquired by the imaging unit is used to control a safety device or perform automatic driving control. Such an imaging unit is disposed outside the vehicle in some cases. In this case, a translucent body such as a protective cover or a lens is disposed at an exterior of the imaging unit.

Therefore, foreign matters such as raindrops (liquid droplets), mud, and dust may adhere to the translucent body. In a case where a foreign matter adheres to the translucent body, in some cases, the foreign matter is reflected in an image acquired by the imaging unit, and it is not possible to obtain a clear image.

In recent years, a device that removes a foreign matter adhering to a translucent body by vibrating the translucent body has been developed. In such a device, the translucent body is disposed at a tubular vibrator, and the translucent body is vibrated by vibrating the vibrator with a piezoelectric element or the like. An inner-layer optical component such as an inner-layer lens is disposed inside the vibrator.

However, in some cases, the vibration of the translucent body and/or the vibrator is attenuated depending on the position of the inner-layer optical component disposed inside the vibrator. For example, a gap is provided between the translucent body and the inner-layer optical component, and the vibration attenuation occurs depending on the dimension of the gap. As a result, there is a problem that it is not possible to sufficiently remove the foreign matter adhering to the translucent body. This is a new problem discovered by the inventors of example embodiments of the present invention.

For example, in a case where the translucent body is vibrated, an acoustic wave is generated by the vibration. The acoustic wave generated from the translucent body is reflected by the inner-layer optical component, and a standing wave including an antinode and a node of the acoustic wave is generated. In the antinode of the acoustic wave, the acoustic pressure is increased as compared with other portions, and the air is further compressed.

Therefore, in the antinode of the acoustic wave, the compressed air acts as a damper, and the vibration attenuation occurs. Thus, in a case where the antinode of the acoustic wave is formed at a position at which the translucent body is disposed in the gap between the translucent body and the inner-layer optical component, the vibration of the translucent body is attenuated. As a result, in some cases, it is not possible to sufficiently remove the foreign matter adhering to the translucent body.

In order to dispose the inner-layer optical component to avoid the antinode generated by the reflection of the acoustic wave generated from the translucent body, it is considered that the inner-layer optical component is disposed close to the translucent body, and a gap between the translucent body and the inner-layer optical component is reduced. In this case, the volume of the air in the gap is reduced and the acoustic pressure is increased, regardless of the presence or absence of the standing wave. As a result, the vibration attenuation occurs in some cases.

The present inventors have conducted intensive studies, and discovered and conceived of a configuration in which the attenuation of the vibration is reduced or prevented by reducing or preventing an increase in acoustic pressure in the gap between the translucent body and the inner-layer optical component, and led to development of example embodiments of the present invention.

According to an example embodiment of the present invention, an optical module includes a translucent body, a vibrator that is tubular and supports the translucent body, a piezoelectric element located at the vibrator to vibrate the vibrator, and an inner-layer optical component at an inner side portion of the vibrator. The inner-layer optical component includes an inner-layer lens that faces the translucent body, a first recess that is recessed in a thickness direction of the inner-layer lens and includes a curvature on a surface of the inner-layer lens facing the translucent body, and a gap is located between the translucent body and the first recess of the inner-layer lens.

With such a configuration, it is possible to reduce or prevent the vibration attenuation.

The first recess may overlap a central portion of the translucent body when viewed from a thickness direction of the translucent body.

With such a configuration, it is possible to reduce or prevent the vibration attenuation in the central portion of the translucent body.

When viewed from the thickness direction of the translucent body, a center of the first recess may coincide or substantially coincide with a center of the translucent body.

With such a configuration, it is possible to further reduce or prevent the vibration attenuation in the central portion of the translucent body.

A depth of the first recess may decrease toward an outer side portion from a center of the inner-layer lens when viewed from the thickness direction of the inner-layer lens.

With such a configuration, an acoustic wave generated by the vibration of the translucent body is likely to be dispersed when the acoustic wave is reflected by the first recess, and it is possible to reduce or prevent the vibration attenuation of the translucent body.

The first recess may be spherical or non-spherical.

With such a configuration, the acoustic wave generated by the vibration of the translucent body is further likely to be dispersed, and it is possible to further reduce or prevent the vibration attenuation of the translucent body.

A second recess that is recessed in the thickness direction of the translucent body and includes a curvature may be provided on the surface of the translucent body facing the inner-layer lens.

With such a configuration, the acoustic wave is likely to be dispersed in the second recess, and it is possible to reduce or prevent the vibration attenuation of the translucent body.

The second recess of the translucent body may be recessed in a hemispherical or substantially hemispherical shape.

With such a configuration, the acoustic wave is further likely to be dispersed in the second recess, and it is possible to further reduce or prevent the vibration attenuation of the translucent body.

When viewed from the thickness direction of the translucent body, an outer diameter of the inner-layer lens may be larger than an outer diameter of the second recess of the translucent body.

With such a configuration, it is possible to reduce or prevent the vibration attenuation of the translucent body while improving the optical characteristics.

The curvature of the first recess of the inner-layer lens may be larger than the curvature of the second recess of the translucent body.

With such a configuration, it is possible to reduce or prevent the vibration attenuation of the translucent body while securing an optical path through the inner-layer lens from the translucent body.

The maximum dimension of the gap may be about 0.5 mm or more.

With such a configuration, it is possible to further reduce or prevent the vibration attenuation of the translucent body.

The maximum dimension of the gap may be in a range of about [(n×λ/2)+0.1 mm] or more and about [{(n+1)×λ/2}−0.1 mm] or less, n may indicate an integer of 0 or more, and λ may indicate a wavelength of the acoustic wave generated by the vibration.

With such a configuration, it is possible to further reduce or prevent the vibration attenuation of the translucent body.

The maximum dimension of the gap may be a dimension between the translucent body and the first recess on a straight line passing through a center of the translucent body and a center of the first recess when viewed from a thickness direction of the translucent body.

With such a configuration, it is possible to reduce or prevent the vibration attenuation in the center of the translucent body.

The inner-layer lens may include a flat surface perpendicular or substantially perpendicular to the thickness direction of the inner-layer lens on the surface facing the translucent body, the inner-layer optical component may include a lens holding portion that has a tubular shape and accommodates the inner-layer lens, and the lens holding portion may include a pressing portion that is in contact with the flat surface at an inner side portion of the lens holding portion.

With such a configuration, it is possible to maintain the optical characteristics of the inner-layer lens while maintaining the optical characteristics.

According to another example embodiment of the present invention, an optical device includes the optical module according to the above example embodiment, and an optical element at the optical module.

With such a configuration, it is possible to reduce or prevent the vibration attenuation.

Hereinafter, example embodiments of the present invention will be described with reference to the accompanying drawings. The following descriptions of example embodiments are merely examples in essence, and are not intended to limit the present disclosure or applications of example embodiments of the present disclosure. Further, the drawings are schematic, and the proportions of the respective dimensions and the like do not necessarily match the actual proportions.

### Example Embodiment 1

### Optical Device

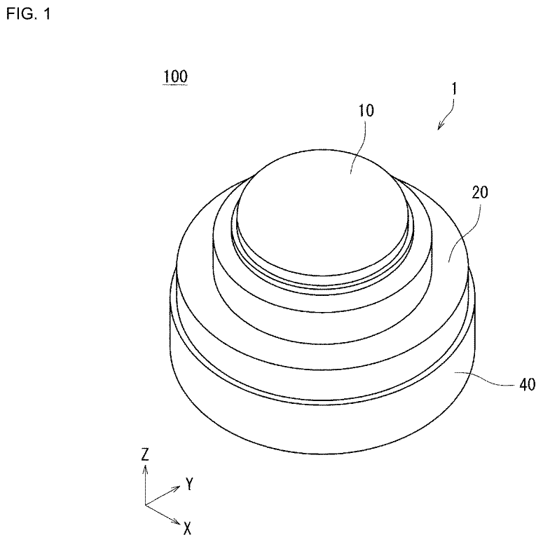

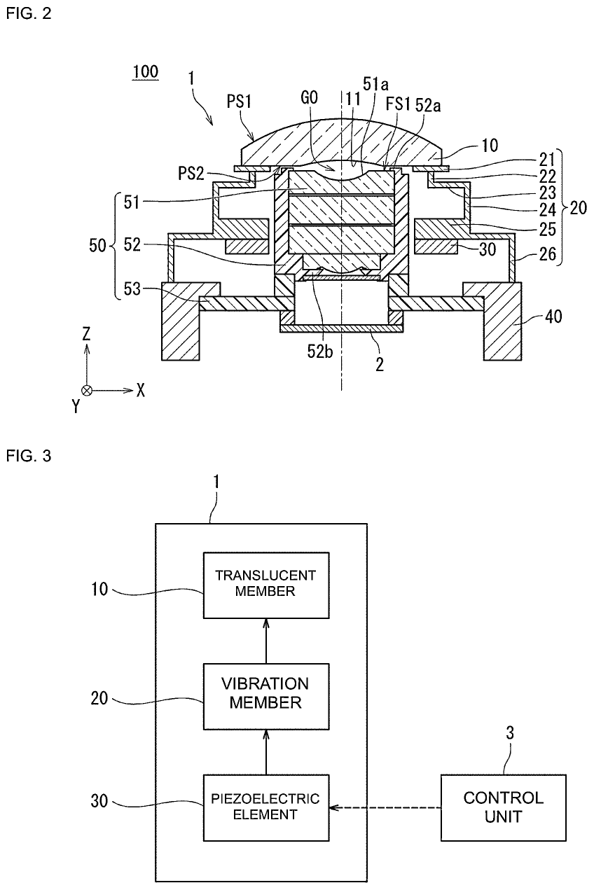

FIG. 1 is a schematic perspective view showing an example of an optical device 100 in Example Embodiment 1 according to the present invention. FIG. 2 is a schematic cross-sectional view showing an example of a configuration of the optical device 100 in Example Embodiment 1 according to the present invention. The X, Y, and Z-directions in the drawings indicate a longitudinal direction, a lateral direction, and a height direction of the optical device 100.

As shown in FIGS. 1 and 2, the optical device 100 includes an optical module 1 and an optical element 2. The optical element 2 is disposed at the optical module 1. Specifically, the optical element 2 is disposed inside the optical module 1.

In the present example embodiment, an example in which the optical device 100 is an imaging device will be described.

The optical device 100 is attached to, for example, a front or rear of a vehicle and images an imaging target. The place where the optical device 100 is attached is not limited to the vehicle, and the optical device 100 may be attached to another device such as a ship or an aircraft.

The optical element 2 is an imaging element, and is, for example, a CMOS, a CCD, a bolometer, or a thermopile that receives light having a wavelength in any of the visible region or the far infrared region.

In a case where the optical device 100 is attached to a vehicle or the like and is used outdoors, foreign matters such as raindrops, mud, and dust may adhere to a translucent body 10 of the optical module 1 that is disposed in a viewing field direction of the optical element 2 and covers the outside. The optical module 1 can generate vibration in order to remove foreign matters such as raindrops adhering to the translucent body 10.

### Optical Module

As shown in FIGS. 1 and 2, the optical module 1 includes a translucent body 10, a vibrator 20, a piezoelectric element 30, a fixing portion 40, and an inner-layer optical component 50. The fixing portion 40 is not an essential configuration in the optical module 1.

### Translucent body

The translucent body 10 has translucency in which energy rays or light having a wavelength to be detected by the optical element 2 is transmitted through the translucent body 10. In the present example embodiment, the translucent body 10 is a cover to protect the optical element 2 and the inner-layer optical component 50 from adhering of foreign matters. In the optical device 100, the optical element 2 detects the energy ray or the light through the translucent body 10.

As a material for forming the translucent body 10, for example, translucent plastic, glass such as quartz and borosilicate, translucent ceramics, synthetic resin, or the like can be used. The strength of the translucent body 10 can be increased, for example, by forming the translucent body 10 with tempered glass. In the present example embodiment, the translucent body 10 is formed of BK-7 (borosilicate glass).

The translucent body 10 has, for example, a dome shape. The translucent body 10 preferably has a circular shape when viewed from a height direction (Z-direction) of the optical module 1. The shape of the translucent body 10 is not limited thereto.

In the present example embodiment, the translucent body 10 includes a first main surface PS1 and a second main surface PS2 on an opposite side of the first main surface PS1. The first main surface PS1 is a main surface located at the outer side a continuous curved surface. Specifically, the first main surface PS1 is curved roundly. The second main surface PS2 is a main surface located at the inner side portion of the translucent body 10. A recess 11 is provided on a flat surface of the second main surface PS2. In the present specification, the recess 11 may be referred to as a second recess.

Specifically, the second main surface PS2 is a surface that faces the inner-layer optical component 50 in the translucent body 10. The recess 11 that is recessed in the thickness direction (Z-direction) of the translucent body 10 and includes a curvature is located at the second main surface PS2. For example, the recess 11 is provided at the center of the translucent body 10 when viewed from the thickness direction (Z-direction) of the translucent body 10, and has a circular shape. For example, the recess 11 is recessed in a hemispherical or substantially hemispherical shape.

An outer peripheral end portion of the translucent body 10 is bonded to the vibrator 20. Specifically, the second main surface PS2 of the translucent body 10 and a vibration flange 21 of the vibrator 20 are bonded to each other along an outer periphery of the translucent body 10 when viewed from the thickness direction (Z-direction) of the translucent body 10. The translucent body 10 and the vibrator 20 can be bonded to each other using, for example, an adhesive or a brazing material. Alternatively, thermal pressure bonding, anodic bonding, or the like can be used.

### Vibrator

The vibrator 20 preferably has a tubular shape and supports the translucent body 10. The vibrator 20 vibrates the translucent body 10 by being vibrated by the piezoelectric element 30.

The vibrator 20 includes the vibration flange 21, a first tubular member 22, a spring portion 23, a second tubular member 24, a vibration plate 25, and a connection portion 26. The connection portion 26 is not an essential configuration in the vibrator 20.

The vibration flange 21 includes an annular plate when viewed in the height direction (Z-direction) of the optical module 1. The vibration flange 21 is disposed along the outer periphery of the translucent body 10 and is bonded to the translucent body 10. The vibration flange 21 stably supports the translucent body 10 by being in surface contact with the translucent body 10.

The first tubular member 22 preferably has a tubular shape having one end and the other end. The first tubular member 22 is formed by a hollow member in which a through-hole is provided. The through-hole is provided in the height direction (Z-direction) of the optical module 1, and openings of the through-hole are provided at the one end and the other end of the first tubular member 22. The first tubular member 22 has, for example, a cylindrical shape. The outer shape of the first tubular member 22 and the opening of the through-hole preferably have a circular shape when viewed from the height direction of the optical module 1.

The vibration flange 21 is provided at the one end of the first tubular member 22, and the spring portion 23 is provided at the other end of the first tubular member 22. The first tubular member 22 is supported by the spring portion 23 while supporting the vibration flange 21.

The spring portion 23 includes a leaf spring that supports the other end of the first tubular member 22. The spring portion 23 is configured to be elastically deformed. The spring portion 23 supports the other end of the first tubular member 22 having a cylindrical shape and extends toward the outer side portion of the first tubular member 22 from a position at which the spring portion 23 supports the other end of the first tubular member 22.

The spring portion 23 preferably has a plate shape. The spring portion 23 has a hollow circular shape in which a through-hole is provided, and extends to surround the periphery of the first tubular member 22 in a circular shape. In other words, the spring portion 23 has an annular plate shape. The annular plate shape means a shape in which a plate-shaped structure preferably has a ring shape. The outer shape of the spring portion 23 and an opening of the through-hole preferably have a circular shape when viewed from the height direction (Z-direction) of the optical module 1.

The spring portion 23 connects the first tubular member 22 and the second tubular member 24. Specifically, the spring portion 23 is connected to the first tubular member 22 on an inner peripheral side of the spring portion 23 and is connected to the second tubular member 24 on an outer peripheral side of the spring portion 23.

The second tubular member 24 preferably has a tubular shape having one end and the other end. The second tubular member 24 is located at the outer side portion of the first tubular member 22 when viewed from the height direction (Z-direction) of the optical module 1, and supports the spring portion 23. The spring portion 23 is connected to the one end of the second tubular member 24. The vibration plate 25 is connected to the other end of the second tubular member 24.

The second tubular member 24 is formed by a hollow member in which a through-hole is provided. The through-hole is provided in the height direction (Z-direction) of the optical module 1, and openings of the through-hole are provided at the one end and the other end of the second tubular member 24. The second tubular member 24 has, for example, a cylindrical shape. The outer shape of the second tubular member 24 and the opening of the through-hole preferably have a circular shape when viewed from the height direction of the optical module 1.

The vibration plate 25 is a plate-shaped structure that extends from the other end of the second tubular member 24 toward the inner side portion. The vibration plate 25 supports the other end of the second tubular member 24 and extends toward the inner side portion of the second tubular member 24 from a position at which the vibration plate 25 supports the other end of the second tubular member 24.

The vibration plate 25 has a hollow circular shape in which a through-hole is provided, and is provided along an inner periphery of the second tubular member 24. The vibration plate 25 has an annular plate shape.

The connection portion 26 connects the vibration plate 25 and the fixing portion 40 to each other. The connection portion 26 extends toward the outer side portion from the outer peripheral end portion of the vibration plate 25 and is bent toward the fixing portion 40. The connection portion 26 is supported by the fixing portion 40. The connection portion 26 is configured to have a node, and thus the vibration from the vibration plate 25 is less likely to be transmitted.

In the present example embodiment, the first tubular member 22, the spring portion 23, the second tubular member 24, the vibration plate 25, and the connection portion 26 are integrally formed. The first tubular member 22, the spring portion 23, the second tubular member 24, the vibration plate 25, and the connection portion 26 may be formed separately or may be formed by separate members.

The elements of the above-described vibrator 20 may be made of, for example, metal or ceramics. As the metal, for example, stainless steel, 42 alloy, 50 alloy, Invar, super Invar, cobalt, aluminum, duralumin, or the like can be used. Alternatively, the elements of the vibrator 20 may be made of ceramics such as alumina and zirconia, or may be made of a semiconductor such as Si. Further, the elements of the vibrator 20 may be covered with an insulating material. The elements of the vibrator 20 may be subjected to a black body treatment.

The shapes and the dispositions of the elements of the vibrator 20 are not limited to the examples described above.

### Piezoelectric Element

The piezoelectric element 30 is disposed at the vibrator 20 and vibrates the vibrator 20. The piezoelectric element 30 is provided on the main surface of the vibration plate 25. Specifically, the piezoelectric element 30 is provided on a main surface of the vibration plate 25 on an opposite side of a side where the translucent body 10 is located. The piezoelectric element 30 vibrates the second tubular member 24 in a penetration direction (Z-direction) by vibrating the vibration plate 25. For example, the piezoelectric element 30 vibrates when a voltage is applied.

The piezoelectric element 30 has a hollow circular shape in which a through-hole is provided. In other words, the piezoelectric element 30 has an annular plate shape. The outer shape of the piezoelectric element 30 and an opening of the through-hole preferably have a circular shape when viewed from the height direction (Z-direction) of the optical module 1.

The outer shape of the piezoelectric element 30 and the opening of the through-hole are not limited thereto.

The piezoelectric element 30 includes a piezoelectric body and an electrode. As a material of the piezoelectric body, for example, appropriate piezoelectric ceramics such as barium titanate (BaTiO₃), lead zirconate titanate (PZT: PbTiO₃·PbZrO₃), lead titanate (PbTiO₃), lead metaniobate (PbNb₂O₆), bismuth titanate (Bi₄Ti₃O₁₂), and (K,Na)NbO₃, or appropriate piezoelectric single crystals such as LiTaO₃ and LiNbO₃ can be used. The electrode may be, for example, a Ni electrode. The electrode may be an electrode formed with a metal thin film of Ag, Au, or the like, which is formed by a sputtering method. Alternatively, the electrode can be formed by plating or vapor deposition in addition to sputtering.

The fixing portion 40 fixes the vibrator 20. The fixing portion 40 also fixes the inner-layer optical component 50. The fixing portion 40 preferably has a tubular shape. For example, the fixing portion 40 has a cylindrical shape. The shape of the fixing portion 40 is not limited to the cylindrical shape. The fixing portion 40 may be formed integrally with the vibrator 20.

### Inner-Layer Optical Component

As shown in FIG. 2, the inner-layer optical component 50 is an optical component disposed inside the vibrator 20. For example, the inner-layer optical component 50 is a lens module.

In the present example embodiment, the inner-layer optical component 50 includes an inner-layer lens 51, a lens holding portion 52, and an inner-layer flange 53.

The inner-layer lens 51 includes a plurality of lenses. The inner-layer lens 51 is disposed on an optical path of the optical element 2 at the inner side portion of the vibrator 20 and faces the translucent body 10. A recess 51a is formed on the surface of the inner-layer lens 51 facing the translucent body 10. Specifically, the recess 51a is formed on the surface of a lens disposed at a position facing the translucent body 10 among the plurality of lenses of the inner-layer lens 51. In the present specification, the recess 51a may be referred to as a first recess 51a.

The first recess 51a is formed on the surface of the inner-layer lens 51 facing the translucent body 10 to be recessed in the thickness direction (Z-direction) of the inner-layer lens 51 and to have a curvature. The first recess 51a is recessed in the direction separated away from the translucent body 10.

The depth of the first recess 51a decreases toward the outer side portion from the center of the inner-layer lens 51 when viewed from the thickness direction of the inner-layer lens 51. The first recess 51a has a circular shape when viewed from the thickness direction (Z-direction) of the inner-layer lens 51. For example, the first recess 51a preferably has a spherical shape or a non-spherical shape.

In the present example embodiment, the first recess 51a preferably has a spherical shape. Specifically, the first recess 51a is formed on the surface of the inner-layer lens 51 facing the translucent body 10 to be recessed in a hemispherical or substantially hemispherical shape in the thickness direction of the inner-layer lens 51. The first recess 51a preferably has the central portion of the inner-layer lens 51 when viewed from the thickness direction (Z-direction) of the inner-layer lens 51. When viewed from the thickness direction of the inner-layer lens 51, a flat surface FS1 is formed at an outer periphery of the first recess 51a. The flat surface FS1 extends in a direction perpendicular to the thickness direction (Z-direction) of the inner-layer lens 51.

The inner-layer lens 51 is, for example, a spherical lens. The inner-layer lens 51 is not limited to the spherical lens, and may be an aspherical lens.

The lens holding portion 52 holds the inner-layer lens 51. The lens holding portion 52 preferably has a tubular shape having one end and the other end. Specifically, the lens holding portion 52 has a cylindrical shape and holds an outer periphery of the inner-layer lens 51.

The lens holding portion 52 includes a pressing portion 52a that is in contact with the flat surface FS1 of the inner-layer lens 51 at an inner side portion of the lens holding portion 52. The pressing portion 52a protrudes toward the inner side portion of the lens holding portion 52 at one end of the lens holding portion 52. The pressing portion 52a preferably has a ring shape when viewed from a height direction (Z-direction) of the inner-layer optical component 50. The pressing portion 52a is in contact with the flat surface FS1 of the inner-layer lens 51 and presses the flat surface FS1 in the thickness direction (Z-direction) of the inner-layer lens 51.

In the present example embodiment, a contact portion 52b that is in contact with the inner-layer lens 51 is provided at the other end of the lens holding portion 52. The contact portion 52b protrudes toward the inner side portion of the lens holding portion 52 on the other end side of the lens holding portion 52. For example, the contact portion 52b preferably has a ring shape when viewed from the height direction (Z-direction) of the inner-layer optical component 50. The inner-layer lens 51 is accommodated in the lens holding portion 52 and is pressed against the contact portion 52b by the pressing portion 52a. As a result, the inner-layer lens 51 is held in the lens holding portion 52. The contact portion 52b may be attachable to and detachable from the lens holding portion 52. For example, the contact portion 52b may have an annular shape and may be attached to the lens holding portion 52 by a screw structure.

The inner-layer flange 53 extends toward an outer side portion from an outer wall of the lens holding portion 52.

Specifically, the inner-layer flange 53 is connected to the other end of the lens holding portion 52 and extends toward the fixing portion 40. The inner-layer flange 53 preferably has an annular plate shape when viewed from the height direction (Z-direction) of the optical module 1. An outer periphery of the inner-layer flange 53 is connected to the fixing portion 40. The inner-layer flange 53 is fixed to the inner side portion of the vibrator 20 by being supported by the fixing portion 40.

FIG. 3 is a block diagram showing an example of a functional configuration of the optical device 100 in Example Embodiment 1 according to the present invention. As shown in FIG. 3, the piezoelectric element 30 is controlled by a control unit 3 (controller). The control unit 3 is configured or programmed to apply a drive signal to generate the vibration to the piezoelectric element 30. The control unit 3 is connected to the piezoelectric element 30, for example, with a power supply conductor interposed therebetween. The piezoelectric element 30 vibrates in the height direction (Z-direction) of the optical module 1 based on the drive signal from the control unit 3. The piezoelectric element 30 is vibrated to vibrate the vibrator 20, and the vibration of the vibrator 20 is transmitted to the translucent body 10 to vibrate the translucent body 10. As a result, foreign matters such as raindrops adhering to the translucent body 10 are removed.

The control unit 3 can be realized by, for example, a semiconductor element or the like. For example, the control unit 3 can be configured by a microcomputer, a central processing unit (CPU), a micro processing unit (MPU), a graphics processing unit (GPU), a digital signal processor (DSP), a field programmable gate array (FPGA), or an application specific integrated circuit (ASIC). The function of the control unit 3 may be realized by only hardware or by a combination of hardware and software.

For example, the control unit 3 realizes a predetermined function by reading data or a program stored in a storage unit and performing various types of arithmetic processing.

The control unit 3 may be provided in the optical device 100, or may be provided in a control device different from the optical device 100. For example, in a case where the optical device 100 does not include the control unit 3, the optical device 100 may be controlled by a control device including the control unit 3. Alternatively, the optical module 1 may include the control unit 3.

### Regarding A Gap

Next, a gap between the translucent body 10 and the inner-layer lens 51 in the optical module 1 will be described.

Returning to FIG. 2, a gap G0 is located between the translucent body 10 and the inner-layer lens 51.

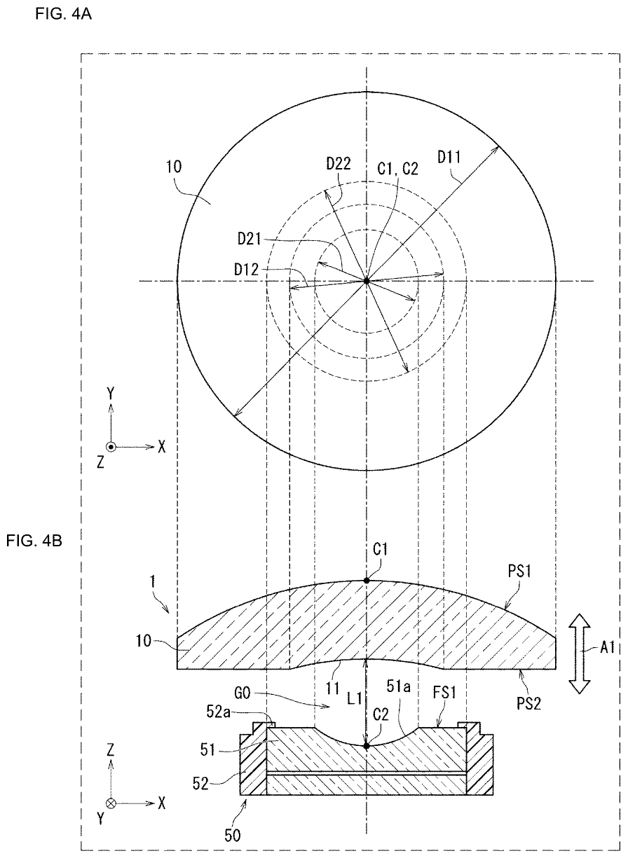

FIGS. 4A and 4B is a schematic view for describing the gap G0 between the translucent body 10 and the inner-layer lens 51. FIG. 4A shows a schematic view of the translucent body 10 when viewed from the first main surface PS1 side. FIG. 4B shows a schematic cross-sectional view of the vicinity of the translucent body 10. In FIGS. 4A and 4B, the reference sign D11 indicates an outer diameter of the translucent body 10, the reference sign D12 indicates an outer diameter of the second recess 11 of the translucent body 10, the reference sign D21 indicates an outer diameter of the first recess 51a of the inner-layer lens 51, and the reference sign D22 indicates an outer diameter of the inner-layer lens 51. The reference sign A1 indicates a vibration direction of the translucent body 10. The outer diameter D12 of the second recess 11 means a diameter of an outer edge that defines the second recess 11 on the second main surface PS2 of the translucent body 10. The outer diameter D22 of the first recess 51a means a diameter of an outer edge that defines the first recess 51a on the surface of the inner-layer lens 51 facing the translucent body 10. The reference signs D11, D12, D21, and D22 are dimensions when viewed from the height direction (Z-direction) of the optical module 1.

In the present example embodiment, when viewed from the height direction (Z direction) of the optical module 1, the outer diameter D12 of the second recess 11 is larger than the outer diameter D22 of the first recess 51a of the inner-layer lens 51. The outer diameter D22 of the inner-layer lens 51 is larger than the outer diameter D12 of the second recess 11. By making the outer diameter D22 of the inner-layer lens 51 larger than the outer diameter D12 of the second recess 11, light incident from the translucent body 10 is easily incident to the optical element 2 through the inner-layer lens 51. As a result, it is possible to improve the optical characteristics.

In addition, the curvature of the first recess 51a of the inner-layer lens 51 is larger than the curvature of the second recess 11 of the translucent body 10. As a result, it is easy to secure an optical path that passes through the inner-layer lens 51 from the translucent body 10.

As shown in FIGS. 4A and 4B, the gap G0 is located between the translucent body 10 and the inner-layer lens 51. Specifically, the gap G0 is located between the second main surface PS2 of the translucent body 10 and the surface of the inner-layer lens 51 facing the second main surface PS2 of the translucent body 10.

The first recess 51a is located at a position overlapping with the central portion of the translucent body 10 when viewed from the thickness direction (Z-direction) of the translucent body 10. The central portion of the translucent body 10 means a central portion of the translucent body 10 when viewed from the first main surface PS1 side of the translucent body 10.

For example, the central portion of the translucent body 10 is a circular region centered on a center C1 of the translucent body 10, when viewed from the first main surface PS1 side of the translucent body 10. For example, the diameter of the central portion of the translucent body 10 is about ⅔ times or less the outer diameter D1 of the translucent body 10, when viewed from the first main surface PS1 side, for example. Preferably, the diameter of the central portion may be about ½ times or less the outer diameter D1 of the translucent body 10, for example. The diameter of the central portion may be about ⅓ times or more the outer diameter D1 of the translucent body 10, for example.

The center C2 of the first recess 51a substantially coincides with the center C1 of the translucent body 10 when viewed from the thickness direction (Z-direction) of the translucent body 10. In the present specification, “substantially coinciding” may include an error of ±5% or less. In other words, a center line of the translucent body 10 extending along the height direction (Z-direction) of the optical module 1 passes through the center C1 of the translucent body 10 and the center C2 of the inner-layer lens 51.

When viewed from the thickness direction (Z-direction) of the inner-layer lens 51, the depth of the first recess 51a decreases toward the outer side portion from the center C2 of the inner-layer lens 51. When viewed from the thickness direction (Z-direction) of the translucent body 10, the depth of the second recess 11 decreases toward the outer side portion from the center C1 of the translucent body 10. The depth of the first recess 51a means a dimension of the inner-layer lens 51 in the thickness direction (Z-direction), and the depth of the second recess 11 means a dimension of the translucent body 10 in the thickness direction (Z-direction).

The gap G0 decreases toward the outer side portion from the center C1 of the translucent body 10 and the center C2 of the inner-layer lens 51. Specifically, the dimension of the gap G0 in the height direction (Z-direction) of the optical module 1 decreases toward the outer side portion from the center C1 of the translucent body 10 and the center C2 of the inner-layer lens 51.

In the present example embodiment, when viewed from the thickness direction (Z-direction) of the translucent body 10, the center C2 of the first recess 51a coincides or substantially coincides with the center C1 of the translucent body 10. Therefore, in the gap G0, a dimension between the translucent body 10 and the first recess 51a on a straight line passing through the center C1 of the translucent body 10 and the center C2 of the first recess 51a when viewed from the thickness direction (Z-direction) of the translucent body 10 is the largest. In the present specification, the dimension in which the gap G0 is the largest in the height direction (Z-direction) of the optical module 1 is referred to as a “maximum dimension L1 of the gap G0”. The maximum dimension L1 of the gap G0 is preferably about 0.5 mm or more, for example.

As described above, by forming the first recess 51a on the surface of the inner-layer lens 51 facing the translucent body 10, it is possible to disperse the acoustic pressure generated in the gap G0. Specifically, the acoustic wave generated in the gap G0 by the vibration of the translucent body 10 is reflected by the first recess 51a. Since the first recess 51a includes a curvature, that is, has a curved shape, the acoustic wave is reflected in various directions when the acoustic wave abuts on the first recess 51a. As described above, the acoustic wave reflected by the first recess 51a is dispersed, and thus it is possible to reduce or prevent the concentration of the acoustic pressure in the gap G0. As a result, it is possible to reduce or prevent an occurrence of the vibration attenuation.

### Regarding Relationship Between Displacement Amount of Translucent Body and Acoustic Pressure

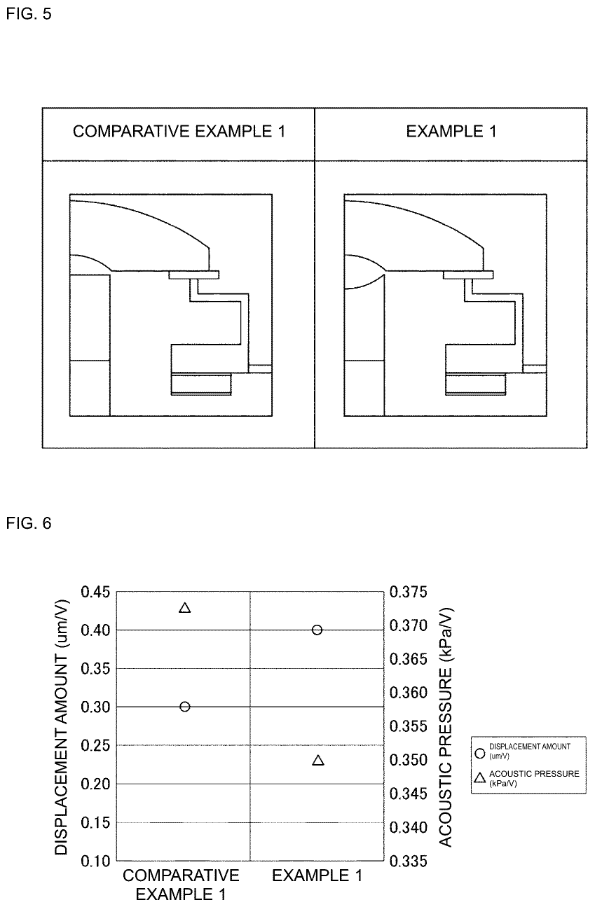

In order to examine a relationship between the displacement amount of the translucent body 10 and the acoustic pressure, simulations were performed using analysis models of Comparative Example 1 and Example 1. The analysis models and the simulation results of Comparative Example 1 and Example 1 will be described with reference to FIGS. 5 to 7. The piezoelectric/acoustic wave analysis (harmonic analysis, strong coupling) was performed by simulation using Femtet manufactured by Murata Software Co., Ltd. In the analysis models, a material of the translucent body 10 was borosilicate glass, a material for forming the vibrator 20 was stainless, and the piezoelectric element 30 was PZT. The translucent body 10 and the vibrator 20 were bonded to each other with epoxy resin. The resonant frequency of the vibrator 20 was set to about 27 kHz, for example.

FIG. 5 is a schematic view for describing Comparative Example 1 and Example 1. As shown in FIG. 5, in Comparative Example 1, an analysis model having an inner-layer lens in which the entirety of a surface facing the translucent body is a flat surface is used. In Comparative Example 1, the first recess is not formed at the inner-layer lens. In Example 1, an analysis model having the configuration of the optical module 1 described in the present example embodiment is used. Example 1 is different from Comparative Example 1 only in that the first recess 51a is provided at the inner-layer lens 51, and the other configurations are the same.

FIG. 6 is a graph showing an example of a simulation result of the displacement amount of the translucent body and the acoustic pressure in Comparative Example 1 and Example 1. The acoustic pressure shown in FIG. 6 indicates the acoustic pressure in the gap G0, and the displacement amount indicates the displacement amount of the central portion of the translucent body 10.

As shown in FIG. 6, in Example 1, the acoustic pressure in the gap G0 is small, and the displacement amount of the translucent body 10 is large, as compared with Comparative Example 1. In Example 1, since the first recess 51a is provided on the surface of the inner-layer lens 51 facing the translucent body 10, when the acoustic wave generated by the vibration of the translucent body 10 is reflected by the first recess 51a in the gap G0, the acoustic wave is likely to be dispersed as compared with Comparative Example 1. Therefore, in Example 1, it is possible to reduce or prevent the concentration of the acoustic waves in the center of the gap G0. As a result, in Example 1, as compared with Comparative Example 1, it is possible to lower the acoustic pressure in the gap G0 and reduce or prevent the vibration attenuation.

On the other hand, in Comparative Example 1, since the first recess is not formed on the surface of the inner-layer lens facing the translucent body and the entire surface is formed to be flat, the acoustic wave reflected by the inner-layer lens is less likely to be dispersed. Therefore, in Comparative Example 1, as compared with Example 1, the acoustic wave in the gap G0 s likely to be concentrated, and the acoustic pressure is likely to increase. Therefore, in Comparative Example 1, as compared with Example 1, it is not possible to reduce or prevent the vibration attenuation and the displacement amount is small.

As described above, in Example 1, as compared with Comparative Example 1, the configuration in which the acoustic wave in the gap G0 is likely to be dispersed has been made, and thus it is possible to reduce the acoustic pressure in the gap G0. As a result, in Example 1, as compared with Comparative Example 1, it is possible to reduce or prevent the vibration attenuation and increase the displacement amount of the translucent body 10.

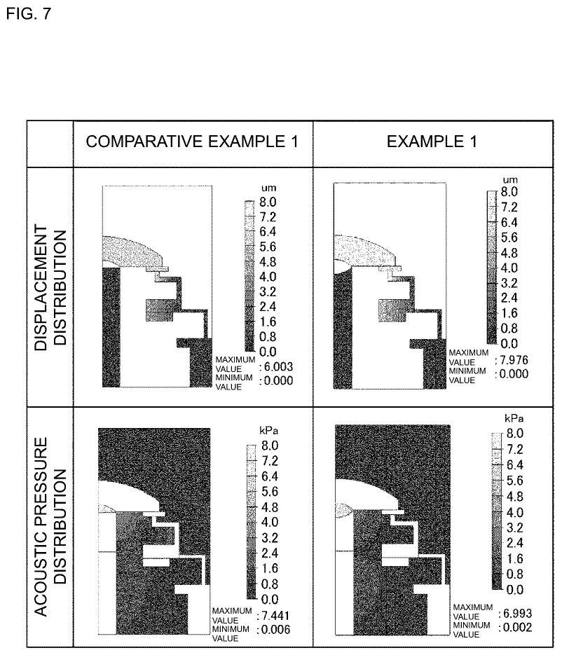

FIG. 7 is a view showing an example of a displacement distribution and an acoustic pressure distribution in Comparative Example 1 and Example 1. As shown in FIG. 7, the maximum displacement amount of the translucent body is about 6 μm in Comparative Example 1, and the maximum displacement amount is about 8.0 μm in Example 1.

On the other hand, in a case of focusing on the acoustic pressure distribution, it can be seen that the acoustic pressure in the gap G0 is reduced in Example 1 as compared with Comparative Example 1. In particular, it can be seen that, in Example 1, the acoustic pressure in the vicinity of the center of the gap G0, that is, in the portion at which the gap G0 is the largest is reduced as compared with Comparative Example 1. Therefore, it can be seen that, in Example 1, as compared with Comparative Example 1, the acoustic wave in the gap G0 is dispersed and the concentration of the acoustic wave is reduced or prevented.

### Regarding Maximum Dimension of Gap

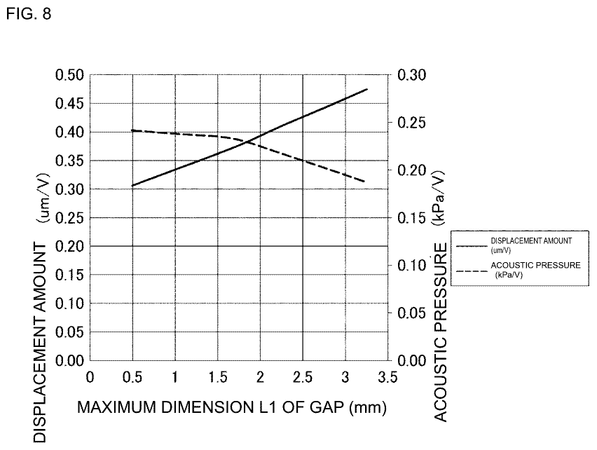

FIG. 8 is a graph showing an example of a relationship between the maximum dimension of the gap and the displacement amount of the translucent body. As shown in FIG. 8, as the maximum dimension L1 of the gap G0 increases, the displacement amount of the translucent body 10 increases. The maximum dimension L1 of the gap G0 may be only about 0.5 mm or more, for example. Preferably, the maximum dimension L1 of the gap G0 is about 1.5 mm or more, for example. More preferably, the maximum dimension L1 of the gap G0 is about 2.25 mm or more, for example.

When the displacement amount of the translucent body 10 is less than about 0.3 μm/V, for example, it is difficult to remove foreign matters such as liquid droplets adhering to the first main surface PS1 of the translucent body 10. In a case where the maximum dimension L1 of the gap G0 is about 0.5 mm or more, for example, the displacement amount of the translucent body 10 is about 0.3 μm/V or more, and the foreign matters adhering to the first main surface PS1 of the translucent body 10 are likely to be removed. In a case where the maximum dimension L1 of the gap G0 is about 1.5 mm or more, for example, the displacement amount of the translucent body 10 is about 0.35 μm/V or more, and the foreign matters adhering to the first main surface PS1 of the translucent body 10 are likely to be removed. Further, in a case where the maximum dimension L1 of the gap G0 is about 2.25 mm or more, for example, the displacement amount of the translucent body 10 is about 0.4 μm/V or more, and the foreign matters adhering to the first main surface PS1 of the translucent body 10 are further likely to be removed.

On the other hand, when the maximum dimension L1 of the gap G0 is too large, there is a possibility that a standing wave in which an acoustic wave from the translucent body 10 toward the inner-layer lens 51 in the gap G0 and an acoustic wave that is reflected by the inner-layer lens 51 and then directed to the translucent body 10 overlap each other is generated.

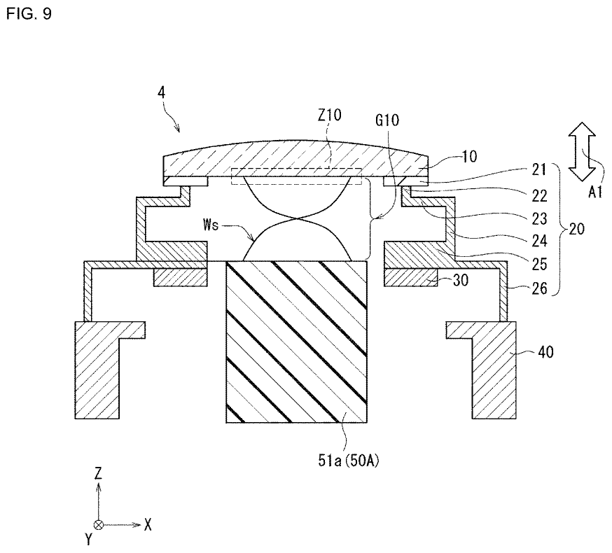

FIG. 9 is a schematic view for describing a standing wave. For convenience of description, in FIG. 9, an example of an optical module 4 in which the surface of an inner-layer lens 51A facing the translucent body 10 is configured as a flat surface will be described.

As shown in FIG. 9, when the translucent body 10 vibrates in the vibration direction A1, an acoustic wave is generated from the translucent body 10 in a gap G10. The acoustic wave generated from the translucent body 10 travels toward the inner-layer lens 51A of an inner-layer optical component 50A and is reflected on the surface of the inner-layer lens 51A. As a result, the acoustic wave traveling from the translucent body 10 to the inner-layer lens 51A and the acoustic wave reflected on the surface of the inner-layer lens 51A overlap with each other, and thus a standing wave Ws including an antinode and a node is generated.

In the standing wave Ws, in a region Z10 that is the antinode of the acoustic wave, the acoustic pressure is increased as compared with acoustic pressure in the other regions, and the air is compressed. Therefore, in the region Z10 that is the antinode of the acoustic wave, the compressed air acts as a damper, and the vibration attenuation (damping) is likely to occur. Thus, when the translucent body 10 is located in the region Z10 that is the antinode of the acoustic wave, the vibration of the translucent body 10 is attenuated.

Here, when the wavelength of the acoustic wave is denoted by “λ”, the antinode of the acoustic wave is generated at a position corresponding to about λ/2, for example. A calculation expression of the wavelength λ is calculated by [wavelength (mm)]=[acoustic velocity (m/s)/frequency (Hz)].

In a case where the acoustic pressure of the region Z10 in which vibration is generated is increased due to the standing wave Ws, the air pressure is increased, and thus the springiness of the air is increased. The springiness of the air has a relationship of being proportional to the air pressure and being inversely proportional to the volume. This is clear from the expression [air spring constant K]=about 10×γ(P+0.1)A/V] of the spring constant of the bellows-type air spring. P indicates the internal pressure, A indicates the effective air spring receiving area, and V indicates the air spring volume.

In a case where the attenuation in the vibration of the free vibration is considered, the critical attenuation rate is calculated by Cc=2√ mk. m indicates the mass, and k indicates the spring constant. The larger the critical attenuation rate Cc is, the easier the vibration is attenuated. Therefore, it is considered that an increase in the spring constant of the air leads to vibration attenuation. From the above description, it can be said that the vibration attenuation occurs by the increase in the acoustic pressure in the region Z10 that is the antinode of the standing wave Ws.

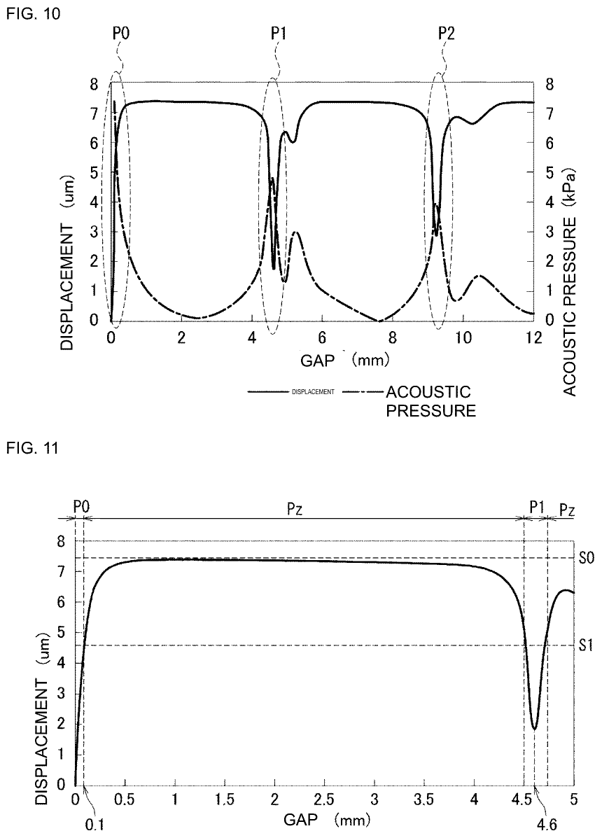

FIG. 10 is a graph showing an example of an analysis result of a relationship between the displacement of the translucent body 10 and the acoustic pressure. FIG. 11 is an enlarged graph of the graph in FIG. 10. The graphs shown in FIGS. 10 and 11 were acquired by performing piezoelectric/acoustic wave analysis (harmonic analysis, strong coupling) using Femtet manufactured by Murata Software Co., Ltd. In the analysis, a model in which a glass plate was disposed on the upper surface of the translucent body 10 in the Z-direction was used, and a distance between the glass plate and the upper surface of the translucent body was changed. An air layer was inserted into a gap between the glass plate and the upper surface of the translucent body 10. Regarding a material of the model, a material for forming the glass plate was borosilicate glass, a material for forming the vibrator 20 was stainless, and the piezoelectric element 30 was PZT. The translucent body 10 and the vibrator 20 were bonded to each other with epoxy resin. The resonant frequency of the vibrator 20 used for the analysis was about 27 kHz, and a wavelength λ of the acoustic wave was set to about 9.2 mm from the acoustic velocity of the air, for example.

As shown in FIGS. 10 and 11, when the distance in the gap between the translucent body 10 and the glass plate in the Z-direction is changed, in regions P1 and P2 corresponding to the integer multiples of the half-wavelength λ/2 of the standing wave Ws, the acoustic pressure is increased and the vibration attenuation occurs, thereby reducing the displacement amount of the translucent body 10. Specifically, in a region in which the distance in the gap between the translucent body 10 and the glass plate in the Z-direction is in the vicinity of about 4.6 mm and about 9.6 mm, for example, the acoustic pressure is increased and the displacement amount of the translucent body 10 is reduced. The displacement amount of the translucent body 10 is also reduced in a region P0 in which the gap between the translucent body 10 and the glass plate is in the vicinity of 0 mm.

From the above description, it is considered that it is possible to reduce or prevent the vibration attenuation of the translucent body 10 by disposing the translucent body 10 to avoid the region P0 in which the gap is in the vicinity of 0 mm, and the regions P1 and P2 corresponding to the half-wavelength of the standing wave Ws.

As an example, a value in which a reduction amount from the maximum displacement amount S0 of the translucent body 10 is set to about 60% is set as a lower limit value S1 of the displacement amount of the translucent body 10. The lower limit value S1 may be set in a range in which liquid droplets adhering to the translucent body 10 can be removed. In FIG. 8, since the maximum displacement amount S0 is about 7.4 μm, the lower limit value S1 is about 4.7 μm, for example. In this case, in a region Pz of the translucent body 10 in which the vibration attenuation is reduced or prevented, the distance of the gap in the Z-direction is about 0.1 mm or more and about 4.5 mm or less, for example. In the case of this numerical range, it is possible to reduce or prevent the vibration attenuation of the translucent body 10 due to the generation of the standing wave Ws.

Here, the vibration attenuation of the translucent body 10 occurs for each integer multiple of the half-wavelength λ/2 of the standing wave Ws. Therefore, in the optical module 4, the dimension of the gap G10 for reducing or preventing the vibration attenuation of the translucent body 10 is in a range of about [(n×λ/2)+0.1 mm] or more and about [{(n+1)×λ/2}−0.1 mm] or less. “n” is an integer of 0 or more, and “λ” is a wavelength of an acoustic wave generated by the vibration.

From the above description, in the optical module 1 according to the present example embodiment, the maximum dimension L1 of the gap G0 between the translucent body 10 and the inner-layer lens 51 is about 0.5 mm or more and is in a range of about [(n×λ/2)+0.1 mm] or more and about [{(n+1)×λ/2}−0.1 mm] or less, for example. In other words, it is considered that, in a case where a relationship of about 0.5 mm≤L1 and [(n×λ/2)+0.1 mm]≤L1≤[{(n+1)×λ/2}−0.1 mm] is established in the maximum dimension L1 of the gap G0, it is possible to reduce or prevent the vibration attenuation of the translucent body 10 due to the standing wave Ws.

In the present example embodiment, the maximum dimension L1 of the gap G0 is a dimension in the central portion of the translucent body 10 and the inner-layer lens 51, and it is possible to reduce or prevent the vibration attenuation due to the standing wave Ws in the central portion of the translucent body 10. As a result, it is possible to increase the displacement amount of the central portion of the translucent body 10.

Preferably, the maximum dimension L1 of the gap G0 is about 0.5 mm≤L1≤(λ/2−0.1) mm (in the case of n=0), for example. As a result, it is possible to reduce or prevent an increase in acoustic pressure in the gap G0 and reduce or prevent the vibration attenuation while reducing the size of the optical module 1.

### Advantageous Effects

According to the optical module 1 and the optical device 100 according to Example Embodiment 1, it is possible to achieve the following advantageous effects.

The optical module 1 includes the translucent body 10, the vibrator 20, the piezoelectric element 30, and the inner-layer optical component 50. The vibrator 20 preferably has a tubular shape and supports the translucent body 10. The piezoelectric element 30 is located at the vibrator 20 to vibrate the vibrator 20. The inner-layer optical component 50 includes the inner-layer lens 51 that faces the translucent body 10. The first recess 51a that is recessed in the thickness direction (Z-direction) of the inner-layer lens 51 and includes a curvature is located on the surface of the inner-layer lens 51 facing the translucent body 10. The gap G0 is located between the translucent body 10 and the first recess 51a of the inner-layer lens 51.

With such a configuration, it is possible to reduce or prevent the vibration attenuation. According to the optical module 1, it is possible to reduce or prevent the concentration of the acoustic pressure in the gap G0 located between the translucent body 10 and the inner-layer lens 51. Specifically, by forming the first recess 51a on the surface of the inner-layer lens 51 facing the translucent body 10, the acoustic wave reflected by the inner-layer lens 51 in the gap G0 is likely to be dispersed. As a result, it is possible to reduce the acoustic pressure of the gap G0, and reduce or prevent the vibration attenuation of the translucent body 10. As a result, it is possible to increase the displacement amount of the translucent body 10 and improve the removal efficiency of liquid droplets adhering to the translucent body 10.

The first recess 51a is formed at the position overlapping with the central portion of the translucent body 10 when viewed from the thickness direction (Z-direction) of the translucent body 10. With such a configuration, it is possible to reduce or prevent the concentration of the acoustic wave in the vicinity of the central portion of the translucent body 10, and reduce or prevent the vibration attenuation in the central portion of the translucent body 10.

The center C2 of the first recess 51a coincides or substantially coincides with the center C1 of the translucent body 10 when viewed from the thickness direction (Z-direction) of the translucent body 10. With such a configuration, it is possible to reduce or prevent the concentration of the acoustic wave in the central portion of the translucent body 10 and reduce or prevent the vibration attenuation in the central portion of the translucent body 10, while improving the optical characteristics.

The depth of the first recess 51a decreases toward the outer side portion from the center C2 of the inner-layer lens 51 when viewed from the thickness direction (Z-direction) of the inner-layer lens 51. With such a configuration, the acoustic wave reflected by the first recess 51a is likely to be dispersed, and it is possible to reduce or prevent the concentration of the acoustic wave in the gap G0. As a result, it is possible to reduce or prevent the vibration attenuation of the translucent body 10.

The first recess 51a preferably has a spherical shape or a non-spherical shape. With such a configuration, the acoustic wave reflected by the first recess 51a is further likely to be dispersed, and it is possible to further reduce or prevent the concentration of the acoustic wave in the gap G0. As a result, it is possible to further reduce or prevent the vibration attenuation of the translucent body 10.

The second recess 11 that is recessed in the thickness direction (Z-direction) of the translucent body 10 and includes a curvature is provided on the surface PS2 of the translucent body 10 facing the inner-layer lens 51. With such a configuration, it is possible to disperse the acoustic wave in the second recess 11 of the translucent body 10, and further reduce or prevent the concentration of the acoustic wave in the gap G0. As a result, it is possible to further reduce or prevent the vibration attenuation of the translucent body 10.

The second recess 11 of the translucent body 10 is recessed in a hemispherical or substantially hemispherical shape. With such a configuration, the acoustic wave is likely to be dispersed in the second recess 11, and it is possible to reduce or prevent the concentration of the acoustic wave in the gap G0. As a result, it is possible to reduce or prevent the vibration attenuation of the translucent body 10.

When viewed from the thickness direction (Z-direction) of the translucent body 10, the outer diameter D22 of the inner-layer lens 51 is larger than the outer diameter D12 of the second recess 11 of the translucent body 10. With such a configuration, it is possible to reduce or prevent the vibration attenuation of the translucent body 10 while improving the optical characteristics.

The curvature of the first recess 51a of the inner-layer lens 51 is larger than the curvature of the second recess 11 of the translucent body 10. With such a configuration, it is easy to secure an optical path that extends from the translucent body 10 through the inner-layer lens 51.

The maximum dimension L1 of the gap G0 is about 0.5 mm or more, for example. With such a configuration, an increase in acoustic pressure is likely to be reduced or prevented in the gap G0, and the vibration attenuation of the translucent body 10 is likely to be reduced or prevented.

The maximum dimension L1 of the gap G0 is in a range of about [(n×λ/2)+0.1 mm] or more and about [{(n+1)×λ/2}−0.1 mm] or less. n indicates an integer of 0 or more, and λ indicates the wavelength of the acoustic wave generated by the vibration. Preferably, the maximum dimension L1 of the gap G0 is about 0.5 mm≤L1≤(λ/2−1) mm (in the case of n=0), for example. With such a configuration, in a case where the standing wave Ws is generated, it is possible to avoid the antinode of the acoustic wave and reduce or prevent the vibration attenuation of the translucent body 10 due to the increase in the acoustic pressure.

The maximum dimension L1 of the gap G0 is a dimension between the translucent body 10 and the first recess 51a on a straight line passing through the center C1 of the translucent body 10 and the center C2 of the first recess 51a when viewed from the thickness direction (Z-direction) of the translucent body 10. With such a configuration, it is possible to reduce or prevent the concentration of the acoustic wave on the straight line passing through the center C1 of the translucent body 10 and the center C2 of the first recess 51a in the gap G0. As a result, it is possible to reduce or prevent the vibration attenuation in the vicinity of the center C1 of the translucent body 10.

The inner-layer lens 51 includes the flat surface FS1 perpendicular to the thickness direction (Z-direction) of the inner-layer lens 51 on the surface facing the translucent body 10. The inner-layer optical component 50 includes the tubular lens holding portion 52 that accommodates the inner-layer lens 51. The lens holding portion 52 includes the pressing portion 52a that is in contact with the flat surface FS1 at the inner side portion of the lens holding portion 52. With such a configuration, it is possible to stably hold the inner-layer lens 51 by the pressing portion 52a of the lens holding portion 52 while reducing or preventing the concentration of the acoustic pressure by the first recess 51a. As a result, it is possible to reduce or prevent falling off of the inner-layer lens 51, and reduce or prevent the misalignment, and thus it is possible to maintain the optical path.

The optical device 100 includes the optical module 1 and the optical element 2 at the optical module 1. With such a configuration, it is possible to exhibit the similar effects to the effects of the optical module 1 described above.

### Modification Example 1

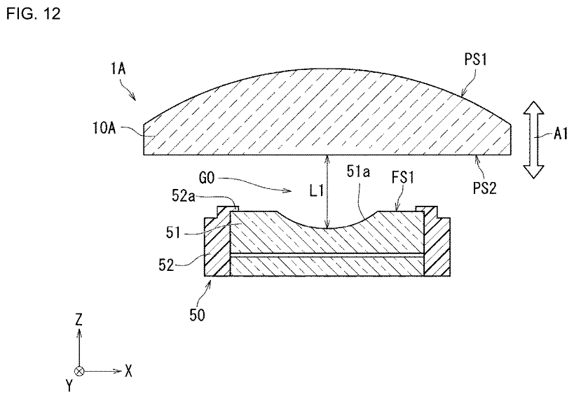

FIG. 12 is a schematic cross-sectional view showing a main configuration of an optical module 1A in Modification Example 1. As shown in FIG. 12, the entire second main surface PS2 of a translucent body 10A may be a flat surface without providing the second recess 11 in the translucent body 10A. Alternatively, in the translucent body 10A, a portion of the second main surface PS2 facing the inner-layer lens 51 may be a flat surface.

Also with such a configuration, it is possible to disperse the acoustic wave in the first recess 51a of the inner-layer lens 51, and reduce or prevent the concentration of the acoustic waves in the gap G0. As a result, it is possible to reduce or prevent the vibration attenuation of the translucent body 10A.

### Modification Example 2

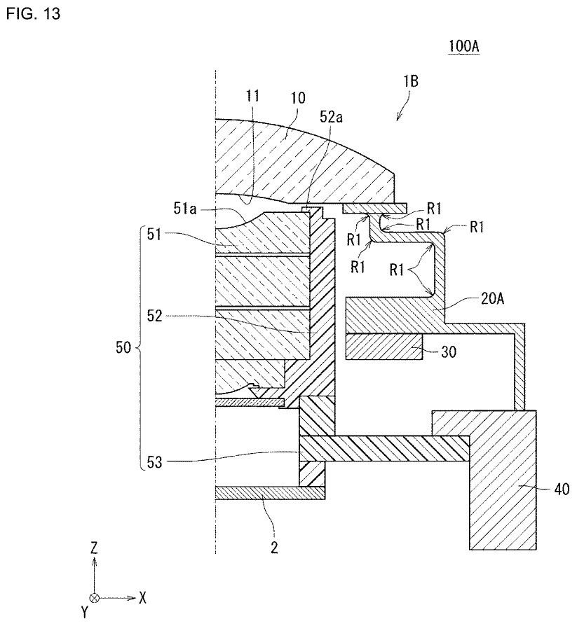

FIG. 13 is a schematic cross-sectional view showing a main configuration of an optical device 100A in Modification Example 3. As shown in FIG. 13, in an optical module 1B of the optical device 100A, a curved portion R1 is provided at the corner portion of a vibrator 20A. The curved portion R1 is provided in a portion to which each of components of the vibrator 20A is connected. The curved portion R1 has a rounded and curved shape.

By providing the curved portion R1 at the corner portion of the vibrator 20A, it is possible to disperse the stress at the time of the vibration of the vibrator 20A. As a result, it is possible to reduce the stress, so that it is possible to reduce or prevent fatigue fracture of the vibrator 20A and improve the reliability.

The present invention has been described in sufficient detail in relation to the example embodiments with reference to the accompanying drawings, but various modifications and changes can be made. It should be understood that such a modification or change is included in the example embodiments of the present invention as long as it does not depart from the scope of the present invention according to the accompanying claims.

The vibration devices and vibration control methods according to the example embodiments of the present invention can be applied to an in-vehicle camera, a surveillance camera, an optical sensor such as LiDAR, or the like used outdoors.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical module comprising:
a translucent body;
a vibrator that is tubular and supports the translucent body;
a piezoelectric element located at the vibrator to vibrate the vibrator; and
an inner-layer optical component located at an inner side portion of the vibrator; wherein
the inner-layer optical component includes an inner-layer lens that faces the translucent body;
a first recess that is recessed in a thickness direction of the inner-layer lens and includes a curvature on a surface of the inner-layer lens facing the translucent body; and
a gap is located between the translucent body and the first recess of the inner-layer lens.

2. The optical module according to claim 1, wherein the first recess overlaps a central portion of the translucent body when viewed from a thickness direction of the translucent body.

3. The optical module according to claim 2, wherein a center of the first recess coincides or substantially coincides with a center of the translucent body when viewed from the thickness direction of the translucent body.

4. The optical module according to claim 1, wherein a depth of the first recess decreases toward an outer side portion from a center of the inner-layer lens when viewed from the thickness direction of the inner-layer lens.

5. The optical module according to claim 1, wherein the first recess has a spherical shape or a non-spherical shape.

6. The optical module according to claim 1, further comprising a second recess that is recessed in a thickness direction of the translucent body and includes a curvature on a surface of the translucent body facing the inner-layer lens.

7. The optical module according to claim 6, wherein the second recess of the translucent body is recessed in a hemispherical or substantially hemispherical shape.

8. The optical module according to claim 6, wherein when viewed from the thickness direction of the translucent body, an outer diameter of the inner-layer lens is larger than an outer diameter of the second recess of the translucent body.

9. The optical module according to claim 6, wherein the curvature of the first recess of the inner-layer lens is larger than the curvature of the second recess of the translucent body.

10. The optical module according to claim 1, wherein a maximum dimension of the gap is about 0.5 mm or more.

11. The optical module according to claim 10, wherein the maximum dimension of the gap is in a range of about [(n×λ/2)+0.1 mm] or more and about [{(n+1)×λ/2}−0.1 mm] or less; and
n indicates an integer of 0 or more, and λ indicates a wavelength of an acoustic wave generated by vibration.

12. The optical module according to claim 10, wherein the maximum dimension of the gap is a dimension between the translucent body and the first recess on a straight line passing through a center of the translucent body and a center of the first recess when viewed from a thickness direction of the translucent body.

13. The optical module according to claim 1, wherein
the inner-layer lens includes a flat surface perpendicular or substantially perpendicular to the thickness direction of the inner-layer lens on a surface facing the translucent body;
the inner-layer optical component includes a lens holding portion that has a tubular shape and accommodates the inner-layer lens; and
the lens holding portion includes a pressing portion that is in contact with the flat surface at an inner side portion of the lens holding portion.

14. An optical device comprising:
the optical module according to claim 1; and
an optical element at the optical module.

15. The optical device according to claim 14, wherein the first recess overlaps a central portion of the translucent body when viewed from a thickness direction of the translucent body.

16. The optical device according to claim 15, wherein a center of the first recess coincides or substantially coincides with a center of the translucent body when viewed from the thickness direction of the translucent body.

17. The optical device according to claim 14, wherein a depth of the first recess decreases toward an outer side portion from a center of the inner-layer lens when viewed from the thickness direction of the inner-layer lens.

18. The optical device according to claim 14, wherein the first recess has a spherical shape or a non-spherical shape.

19. The optical device according to claim 14, further comprising a second recess that is recessed in a thickness direction of the translucent body and includes a curvature on a surface of the translucent body facing the inner-layer lens.

20. The optical device according to claim 19, wherein the second recess of the translucent body is recessed in a hemispherical or substantially hemispherical shape.
